(19) United States
(12) Patent Application Publication
(10) Pub. No.: US 2018/0116774 A1
(43) Pub. Date: May 3, 2018

(54) CLEANING APPLIANCE

(71) Applicant: Dyson Technology Limited, Wiltshire (GB)

(72) Inventors: James David COLEMAN, Bristol (GB); Andrew Nicholas WALTON, Bristol (GB); Luke William DAVISON, Swindon (GB); Robert Lawrence TWEEDIE, Swindon (GB)

(73) Assignee: Dyson Technology Limited, Wiltshire (GB)

(21) Appl. No.: 15/794,565

(22) Filed: Oct. 26, 2017

(30) Foreign Application Priority Data
Oct. 28, 2016 (GB) 1618247.9

(51) Int. Cl. A61C 17/22; A61C 17/36; A46B 13/04; A61C 17/28; A46B 15/00

(52) U.S. Cl. CPC A61C 17/227; A61C 17/36; A46B 13/04; A46B 2200/1066; A61C 17/221; A46B 15/0004; A61C 17/28

(57) ABSTRACT

A dental cleaning appliance includes a nozzle having a fluid chamber, a fluid outlet and a channel extending between the fluid chamber and the fluid outlet. A water reservoir provides water to a pump for generating a burst of pressurized water, which is supplied to the nozzle by a fluid conduit. Following the delivery of the burst of water to the teeth of the user, a valve draws water back into the fluid chamber from the channel to prevent that water from dripping from the fluid outlet before the next water burst is generated by the pump. Simultaneously, air may be drawn into the fluid chamber, for example, through the fluid outlet, for mixing with the next water burst to generate a fluid burst for delivery to the user's teeth.

### REFERENCE TO RELATED APPLICATIONS

This application claims the priority of United Kingdom Application No. 1618247.9, filed Oct. 28, 2016, the entire contents of which are incorporated herein by reference.

### FIELD OF THE INVENTION

The present invention relates to a cleaning appliance. The cleaning appliance is preferably a handheld cleaning appliance, and is preferably a surface treating appliance. In preferred embodiments of the invention, the appliance is a dental cleaning appliance. In a preferred embodiment, the appliance is an electric toothbrush having a fluid delivery system for delivering a fluid to the teeth of the user. This fluid may be toothpaste, or a fluid for improved interproximal cleaning. Alternatively, the appliance may not include any bristles or other elements for brushing teeth, and may be in the form of a dedicated interproximal cleaning appliance. The invention also relates to a cleaning tool for use with a dental cleaning appliance.

### BACKGROUND OF THE INVENTION

Electric toothbrushes generally comprise a cleaning tool which is connected to a handle. The cleaning tool comprises a stem and a brush head bearing bristles for brushing teeth. The brush head comprises a static section which is connected to the stem, and at least one moveable section which is moveable relative to the static section, for example with one of a reciprocating, oscillating, vibrating, pivoting or rotating motion, to impart a brushing movement to bristles mounted thereon. The stem houses a drive shaft which couples with a transmission unit within the handle. The transmission unit is in turn connected to a motor, which may be driven by a battery housed within the handle. The drive shaft and the transmission unit convert rotary or vibratory motion of the motor into the desired movement of the moveable section of the brush head relative to the static section of the brush head.

It is known to incorporate into an electric toothbrush an assembly for generating a jet of fluid for interproximal cleaning. For example, U.S. Pat. No. 8,522,384 describes an electric toothbrush in which the handle of the toothbrush defines a fluid chamber for storing a liquid such as water, and a slidable cover for enabling the fluid chamber to be accessed for replenishment by a user. A fluid path connects the fluid chamber to a nozzle located on a static portion of the brush head. A pump located within the fluid path is actuated upon user operation of an actuator on the handle to pump fluid from the fluid chamber to the nozzle for release under pressure from the nozzle.

### SUMMARY OF THE INVENTION

In a first aspect, the present invention provides a dental cleaning appliance comprising a liquid reservoir for storing a working liquid; and a fluid delivery system for delivering a burst of working liquid to the teeth of the user, the fluid delivery system comprising a fluid emission nozzle comprising a fluid chamber, a fluid outlet and a channel extending between the fluid chamber and the fluid outlet; a liquid burst generator for generating a burst of working liquid from the stored working liquid; a fluid conduit for conveying the burst of working liquid to the nozzle; and means for drawing fluid into the fluid chamber of the nozzle following the delivery of a burst of working liquid to the teeth of the user.

The nozzle comprises a fluid chamber for receiving a burst of working liquid, which is preferably water, and a channel for conveying the burst of working liquid to the fluid outlet for delivery to the teeth of a user. Each burst of working fluid preferably has a volume which is less than 1 ml, more preferably less than 0.5 ml, and in this example is around 0.25 ml. Following the delivery of a burst of working liquid to the teeth of the user, there is a risk that working liquid remaining in the channel of the nozzle may drip from the fluid outlet.

The drawing means is preferably arranged to draw working liquid back into the fluid chamber from the channel. By drawing any such working liquid remaining in the channel back into the fluid chamber, the risk of any such working liquid dripping from the fluid outlet of the nozzle can be reduced. Any such working liquid drawn back into the fluid chamber from the channel may be combined with the next burst of working liquid received from the fluid conduit for delivery to the teeth of the user.

The drawing means is preferably arranged to draw into the fluid delivery system a volume of air as working liquid is drawn back into the fluid chamber from the channel.

In one embodiment, the drawing means is configured to draw air into the fluid chamber through the fluid outlet of the nozzle, so that both air and liquid are drawn into the fluid chamber from the channel. Between the supplies of bursts of working liquid, the fluid chamber may contain a mixture of air and liquid. As the next burst of working liquid is received from the burst generating means, the contents of the fluid chamber combine with the received burst of working liquid to form a burst of working fluid, comprising both liquid and air, which is ejected from the fluid outlet of the nozzle. We have found that providing a volume of air within the nozzle can improve the performance of the appliance in removing debris or other matter located within the interproximal gap. The absence of working fluid within part of the nozzle can enable angular momentum within the burst of working fluid delivered by the liquid burst generator to be generated more rapidly within the nozzle than when the nozzle is substantially full of water prior to the burst of working fluid entering the nozzle from the fluid conduit. A more rapid increase in the angular momentum of the working fluid encourages the working fluid to more rapidly break up and form a divergent spray. This action, together with sufficient momentum in the general direction of the flow, enables matter located within an interproximal gap of a user's teeth to be dislodged by the working fluid.

In another embodiment, the appliance comprises an air inlet through which air is drawn into the fluid delivery system by the drawing means. The air inlet may be arranged to convey air into a fluid chamber of the liquid burst generator, or into the fluid conduit for conveying liquid from the liquid burst generator to the nozzle. In this embodiment, the nozzle comprises an air inlet, spaced from the fluid outlet of the nozzle, through which air is drawn into the nozzle, preferably into the fluid chamber of the nozzle. The air inlet is preferably arranged to convey air into the fluid chamber separately from the liquid drawn into the fluid chamber from the channel. For example, the air inlet may be located opposite to the fluid outlet, or to the channel, so that air is drawn into the fluid chamber from one side and liquid is drawn into the fluid chamber from the opposite side. The nozzle may comprise a first one way valve for inhibiting the emission of working liquid from the fluid chamber through the air inlet. The nozzle may also comprise a second one way valve for inhibiting the drawing of air into the fluid chamber through the fluid outlet. The second one way valve may be located at or adjacent the fluid outlet. For example, the fluid outlet itself may be defined by the fluid outlet of a one way valve, such as a duckbill valve, which has a normally closed position but which opens to allow a burst of working liquid or working fluid to be ejected from the nozzle.

The drawing means may be located within the nozzle. However, the drawing means is preferably located in a fluid flow path extending from the burst generating means to the nozzle. The drawing means may be located adjacent to the nozzle, for example adjacent to a fluid inlet for receiving the burst of working liquid from the fluid conduit. In a preferred embodiment, the drawing means is located adjacent to the burst generating means. The drawing means may be physically spaced from the burst generating means. For example the drawing means may be located within, or between sections of, a conduit for conveying a burst of working liquid towards the nozzle. Alternatively the drawing means may be located in a housing of the burst generating means which is positioned downstream from, preferably adjacent to, a fluid outlet of the burst generating means.

The drawing means is preferably in the form of a valve. The valve preferably comprises a flexible member which is moveable between a first configuration and a second configuration to draw fluid back into the fluid chamber of the nozzle. For example, the drawing means may be in the form of a suck back valve comprising a diaphragm which is flexible between first and second configurations to draw fluid back into the fluid chamber of the nozzle. In a preferred embodiment, the drawing means is preferably a one way valve, such as a duckbill valve, which comprises one or more flexible valve members which are moveable between a first, open configuration and a second, closed configuration. As the valve members move from the first configuration to the second configuration, the valve members creates a local region of relatively low pressure which acts to draw fluid towards the valve, and thus draw fluid back into the fluid chamber of the nozzle.

The liquid burst generator preferably comprises a pump. In a preferred embodiment, the pump is a positive displacement pump. The positive displacement pump preferably comprises a fluid displacement member which is actuable to draw liquid into the pump from the liquid reservoir, and to subsequently urge a burst of liquid from the pump. In a preferred embodiment, the positive displacement pump is in the form of a piston pump, in which the fluid displacement member is a piston which is reciprocally movable between a first position and a second position to draw liquid into the pump and to subsequently urge that liquid from the pump. The liquid burst generator may also comprise a hydraulic accumulator located downstream from the pump for storing working liquid, for example at a pressure in the range from 3 to 10 bar. In this case, the burst generating means may comprises a valve, such as a solenoid valve, located downstream from the accumulator, and a control circuit configured to change the position of the valve from a closed position to an open position to release a burst of liquid from the accumulator.

The drawing means is preferably arranged to draw working liquid back into the fluid chamber of the nozzle as the pump is actuated to draw working liquid into the pump from the liquid reservoir. The drawing means may be arranged to simultaneously inhibit the drawing of working liquid back into the pump from the fluid conduit as the pump is actuated to draw working liquid into the pump from the liquid reservoir.

The drawing means may thus be arranged to perform two different functions. The drawing means is preferably arranged to simultaneously (i) prevent working liquid from being drawn back into the pump from the fluid conduit as the moveable member is actuated to draw a second volume working liquid into the pump from the liquid reservoir, and (ii) draw working liquid back into the fluid chamber from the channel following the delivery of the burst of working liquid to the teeth of the user. Thus, a single component of a fluid delivery system of the appliance may serve to provide these two functions.

In a second aspect, the present invention provides a dental cleaning appliance comprising a nozzle comprising a fluid chamber, a fluid outlet and a channel extending between the fluid chamber and the fluid outlet; a liquid reservoir for storing a working liquid; a pump comprising a fluid displacement member which is actuable to draw a volume of working liquid into the pump from the liquid reservoir, and to urge a burst of working liquid from the pump towards the nozzle; a fluid conduit for conveying the burst of working liquid towards the fluid chamber; and a valve for, following the delivery of the burst of working liquid to the teeth of the user, (i) preventing working liquid from being drawn back into the pump from the fluid conduit as the fluid displacement member is actuated to draw a second volume working liquid into the pump from the liquid reservoir, and (ii) simultaneously, drawing fluid into the fluid chamber.

Features described above in connection with the first aspect of the invention are equally applicable to the second aspect of the invention, and vice versa.

### BRIEF DESCRIPTION OF THE DRAWINGS

Preferred features of the present invention will now be described by way of example only with reference to the accompanying drawings, in which:

FIG. 1(a) is a right side view of a dental cleaning appliance, FIG. 1(b) is a front view of the appliance, and FIG. 1(c) is a left side view of the appliance;

FIG. 2 illustrates schematically components of a fluid delivery system for delivering a burst of a working fluid to the teeth of a user;

FIG. 3 is a right side perspective view, from above, of a cleaning tool of the appliance;

FIG. 4 is a right side perspective view, from above, of a handle of the appliance;

FIG. 5 is a side sectional view of a lower part of the cleaning tool;

FIG. 6 is a perspective view of part of a first embodiment of a fluid delivery system of appliance;

FIG. 7(a) is a section through part of a pump and a valve housing of the fluid delivery system of FIG. 6, with a piston of the pump in a first position, and FIG. 7(b) is a similar view to FIG. 7(a) but with the piston in a second position;

FIG. 8 is a perspective view of a handle conduit system of the fluid delivery system of FIG. 6;

FIG. 9 is a side sectional view of an upper part of the cleaning tool having the conduit system of FIG. 8;

FIG. 10 is a perspective view of a nozzle of the conduit system; and

FIG. 11 is a rear sectional view through a fluid chamber of the nozzle;

FIG. 12 is a perspective view of part of a second embodiment of a fluid delivery system of appliance;

FIG. 13 is a perspective view of a handle conduit system of the fluid delivery system of FIG. 12; and

FIG. 14 is a side sectional view of an upper part of the cleaning tool having the conduit system of FIG. 13.

### DETAILED DESCRIPTION OF THE INVENTION

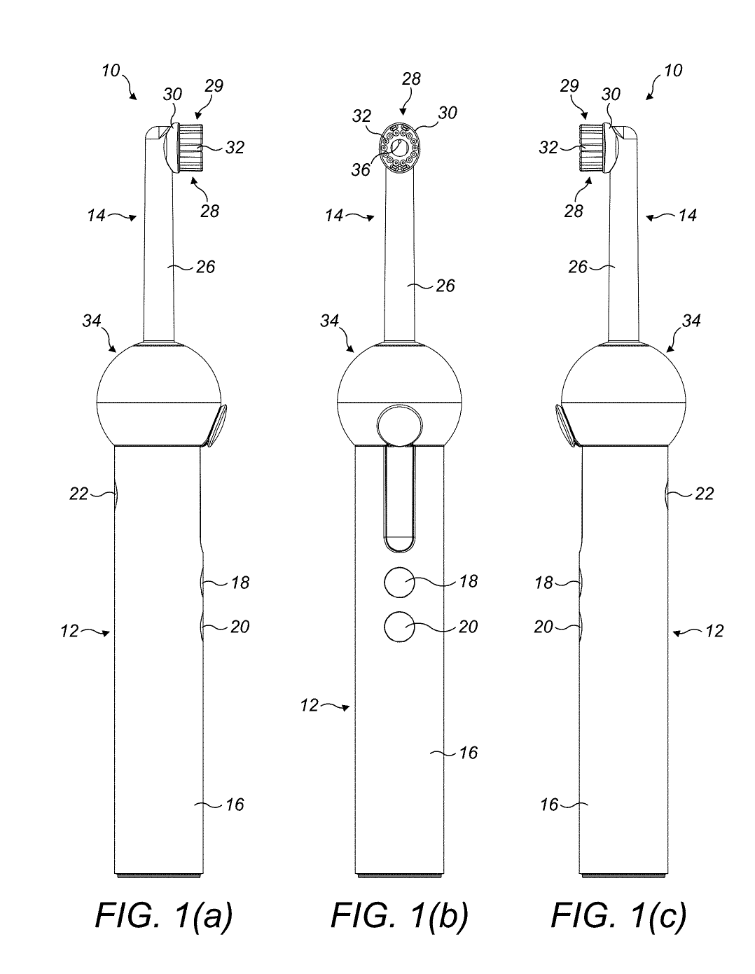

FIGS. 1(a) to 1(c) illustrate external views of an embodiment of a dental cleaning appliance 10. In this embodiment, the appliance is in the form of a handheld appliance, which is in the form of an electric toothbrush having an integrated assembly for dispensing a working fluid for improved interproximal cleaning.

The appliance 10 comprises a handle 12 and a cleaning tool 14. The handle 12 comprises an external body 16 which is gripped by a user during use of the appliance 10. The body 16 is preferably formed from plastics material, and is preferably generally cylindrical in shape. The handle 12 comprises a plurality of user operable buttons 18, 20, 22 which are located within respective apertures formed in the body 16 so as to be accessible to the user. The handle 12 may comprise a display which is positioned so as to be visible to a user during use of the appliance.

The cleaning tool 14 comprises a stem 26 and a head 28. The stem 26 is elongate in shape, which serves to space the head 28 from the handle 12 to facilitate user operability of the appliance 10. In this embodiment, the head 28 of the cleaning tool 14 comprises a brush unit 29, which comprises a bristle carrier 30 and a plurality of bristles 32 mounted on the bristle carrier 30. However, in other embodiments the cleaning tool 14 may be provided without a brush unit 29 so that the appliance is in the form of a dedicated interproximal cleaning appliance for cleaning between the gaps in the user's teeth.

The cleaning tool 14 also comprises a fluid reservoir 34 for storing a working fluid, and a nozzle 36 for delivering one or more bursts of working fluid to the teeth of the user during use of the appliance 10. The fluid reservoir 34 is connected to the stem 26. The fluid reservoir 34 extends at least partially around the stem 26. In this embodiment which includes a brush unit 29, the brush unit 29 extends at least partially around the nozzle 36.

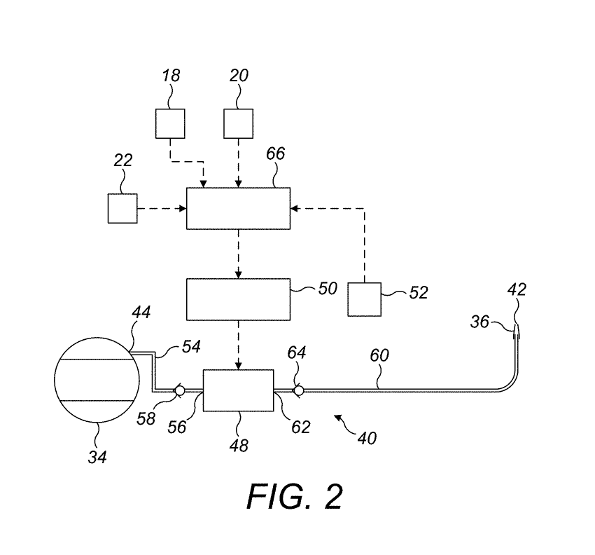

The nozzle 36 forms part of a fluid delivery system 40 for receiving working fluid from the fluid reservoir 34 and for delivering bursts of working fluid to the teeth of a user during use of the appliance 10. Each burst of working fluid preferably has a volume which is less than 1 ml, more preferably less than 0.5 ml, and in this example is around 0.25 ml. The tip of the nozzle 36 comprises a fluid outlet 42 through which a burst of working fluid is delivered to the teeth of the user. The fluid delivery system 40 is illustrated schematically in FIG. 2. In overview, the fluid delivery system 40 comprises a fluid inlet 44 for receiving working fluid from the fluid reservoir 34. In this embodiment, the working fluid is a liquid working fluid, which is preferably water. The fluid delivery system 40 comprises a pump assembly 46 for drawing working fluid from the fluid reservoir 34 through the fluid inlet 44, and for delivering a burst of working fluid to the nozzle 36. The pump assembly 46 is located within the handle 12, and comprises a positive displacement pump 48 and a drive for driving the pump 48. The drive preferably comprises a motor 50. A battery 52 for supplying power to the motor 50 is also located in the handle 12. The battery 52 is preferably a rechargeable battery.

A first conduit 54 connects the fluid inlet 44 of the fluid delivery system 40 to a fluid inlet 56 of the pump 48. A first valve 58 is located between the fluid inlet 44 and the pump 48 to prevent water from returning to the fluid reservoir 34 from the pump 48. A second conduit 60, which, as described below, comprises a plurality of sections, connects a fluid outlet 62 of the pump 48 to the nozzle 36. A second valve 64 is located between the pump 48 and the nozzle 36 to prevent water from returning to the pump 48. A control circuit 66 controls the actuation of the motor 50, and so the motor 50 and the control circuit 66 provide a drive for driving the pump 48. The battery 52 supplies power to the control circuit 66. The control circuit 66 includes a motor controller, which supplies power to the motor 50.

In this embodiment, the control circuit 66 receives signals generated when the user depresses the buttons 18, 20, 22 located on the handle 12 of the appliance 10. Alternatively, or additionally, the control circuit 66 may receive signals which are generated by a sensor located within the appliance, or which are received from a remote device, such as a display or a personal device. For brevity, in the following description the control circuit 66 receives signals which are generated when the user operates one of the buttons 18, 20, 22.

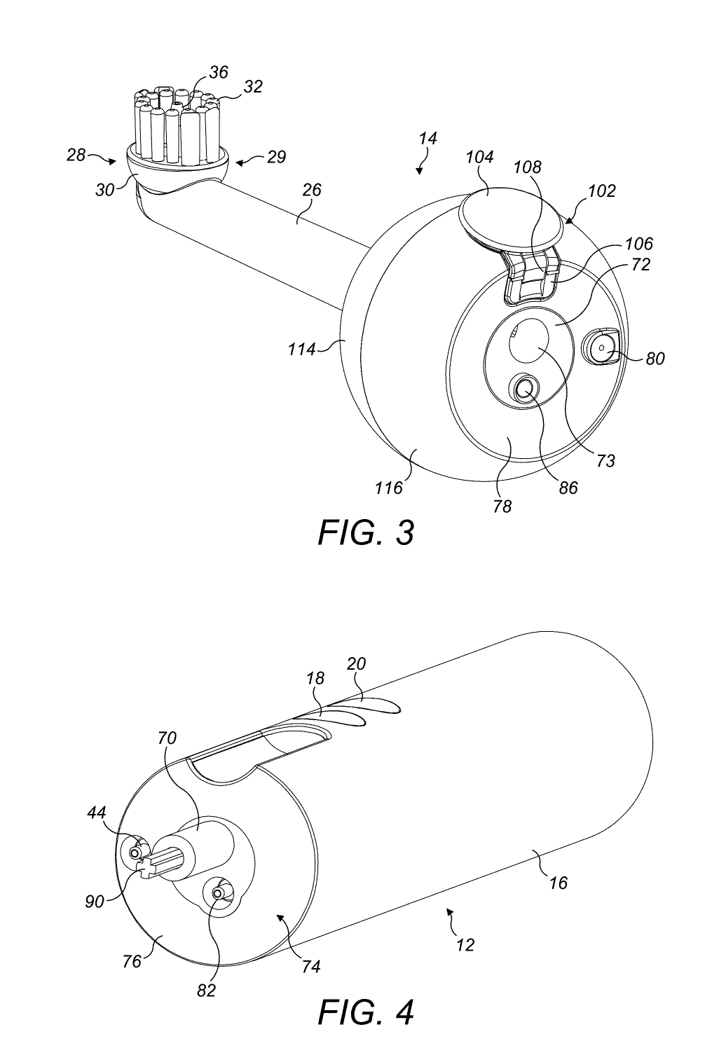

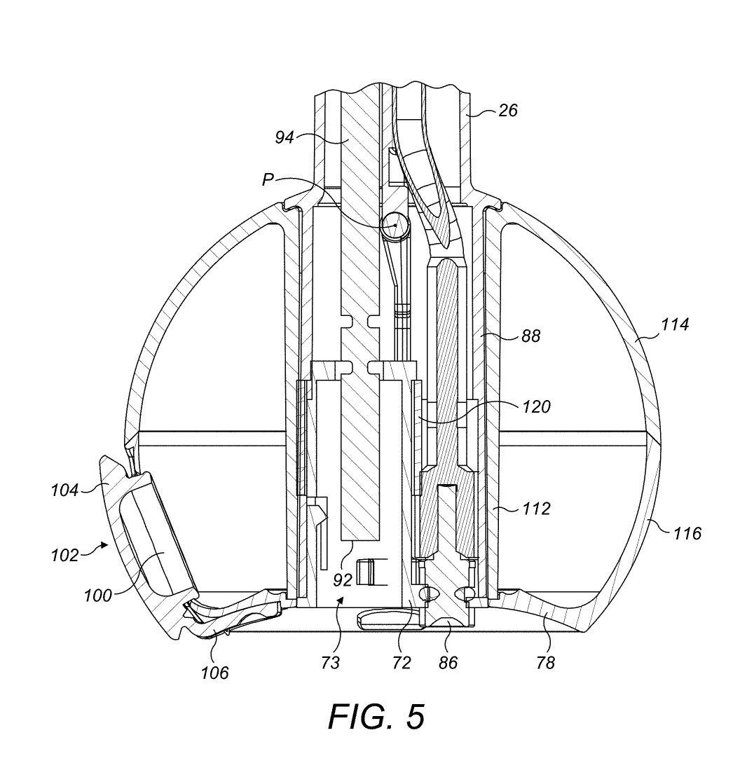

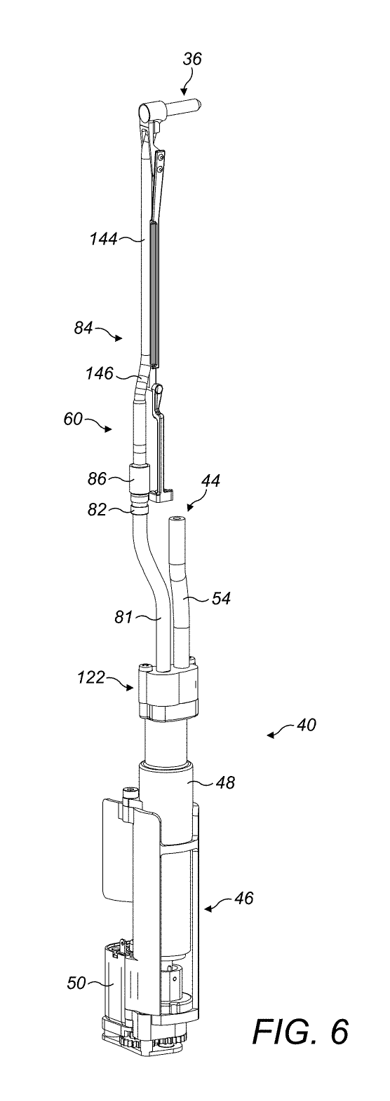

The cleaning tool 14 is detachably connected to the handle 12. With reference to FIGS. 3 to 5, the handle 12 comprises a male connector, preferably in the form of a spigot 70, which is received by a complementary female connector, preferably in the form of a recessed connector 72, of the cleaning tool 14. The recessed connector 72 defines a generally cylindrical recess 73 for receiving the spigot 70. The spigot 70 preferably protrudes outwardly from an end surface 74 of the body 16, and preferably in a direction which is parallel to a longitudinal axis of the handle 12. The end surface 74 defines an annular seat 76 for receiving an annular bottom wall 78 of the fluid reservoir 34 when the cleaning tool 14 is mounted on the handle 12. The annular seat 76 comprises the fluid inlet 44 of the fluid delivery system 40. The fluid inlet 44 receives water from a reservoir fluid outlet port 80 of the fluid reservoir 34 when the cleaning tool 14 is mounted on the handle 12.

With reference also to FIG. 6, the second conduit 60, which connects the fluid outlet 62 of the pump 48 to the nozzle 36, comprises a handle conduit section 81 located within the handle 12, and a cleaning tool conduit section located within the cleaning tool 14. The handle conduit section 81 extends from the fluid outlet 62 of the pump 48 to a handle fluid outlet port 82 located adjacent to the spigot 70. The cleaning tool conduit section 84 comprises a cleaning tool fluid inlet port 86 for receiving water from the handle fluid outlet port 82 when the cleaning tool 14 is connected to the handle 12. The cleaning tool fluid inlet port 86 protrudes from the base of the recessed connector 72. The recessed connector 72 is housed within, and connected to, a relatively wide base section 88 of the stem 26.

As mentioned above, the cleaning tool 14 includes a bristle carrier 30 which is moveable relative to the stem 26. The appliance 10 comprises a drive mechanism for driving the movement of the bristle carrier 30 relative to the stem 26. The drive mechanism comprises a transmission unit connected to the bristle carrier 30, and a drive unit for driving the transmission unit to move the bristle carrier 30 relative to the stem 26.

The handle 12 comprises the drive unit of the drive mechanism. The drive unit comprises a motor, preferably in the form of a dc motor, which is actuated by the control circuit 66 in response to the user depression of one or more of the buttons of the handle 12. The motor of the drive unit is connected via a gear train to a rotatable drive unit coupling member 90 which protrudes outwardly from the spigot 70, and which rotates relative to the body 16 upon actuation of the motor of the drive unit.

The cleaning tool 14 comprises the transmission unit of the drive mechanism. The transmission unit comprises a transmission unit coupling member 92 which couples with, and preferably receives, the drive unit coupling member 90 when the cleaning tool 14 is connected to the handle 12. The transmission unit coupling member 92 is connected to, and is preferably integral with, one end of a connecting rod 94 housed within the stem 26. The other end of the connecting rod 94 is connected to the side surface of the bristle carrier 30 so that periodic rotation of the connecting rod 94 about a 15° angle results in a 15° sweeping movement of the bristle carrier 30 relative to the stem 26.

The fluid reservoir 34 is mounted on, and extends at least partially around, the stem 26 of the cleaning tool 14. In this embodiment, the fluid reservoir 34 is annular in shape, and so surrounds the stem 26. The fluid reservoir 34 is preferably located at or towards the end of the stem 26 which is remote from the head 28, and so in this embodiment extends around the base section 88 of the stem 26. The fluid reservoir 34 preferably has a capacity in the range from 5 to 50 ml, and in this embodiment has a capacity of 25 ml.

The fluid reservoir 34 is filled through a reservoir fluid inlet port 100 formed in the external wall of the fluid reservoir 34. The fluid inlet port 100 is preferably formed in an annular external side wall of the fluid reservoir 34. The reservoir fluid inlet port 100 is sealed by a closure member 102. The closure member 102 is moveable relative to the fluid reservoir 34 between a closed position, as shown in FIG. 3, in which the closure member 102 inhibits the leakage of water from the reservoir fluid inlet port 100, and an open position. In this embodiment, the closure member 102 is pivotably connected to the fluid reservoir 34. The closure member 102 is locatable within, and forms a water-tight seal against, the reservoir fluid inlet port 100. The closure member 102 comprises a head 104 which may be gripped by the user to move the closure member 102 from the closed position to the open position, and which may be pushed by the user towards the reservoir fluid inlet port 100 to return the closure member 102 to the closed position.

The closure member 102 is connected to the fluid reservoir 34 by a pair of arms 106. One end of each arm 106 is connected to the closure member 102, and the other end of each arm 106 is connected to the fluid reservoir 34. In this embodiment, the arms 106 are integral with the closure member 102, with a portion of each arm 106 which is remote from the closure member 102 being connected to the bottom wall 78 of the fluid reservoir 34, for example using an adhesive or by welding. Each arm 106 comprises a hinge 108, which may be formed from a part of the arm 106 which has a locally reduced thickness, to enable the part of the arm 106 which is connected to the closure member 102 to pivot relative to the other part of the arm 106 which is connected to the fluid reservoir 34.

To fill the fluid reservoir 34, the user detaches the cleaning tool 14 from the handle 12, grips the head 104 of the closure member 102 between finger and thumb and pulls it out from the reservoir fluid inlet port 100. The fluid reservoir 34 may then be filled by the user, for example by locating the reservoir fluid inlet port 100 beneath a running tap. Once the fluid reservoir 34 has been filled, the user pushes the head 104 of the closure member 102 back into the reservoir fluid inlet port 100, and reconnects the cleaning tool 14 to the handle 12. The pivoting connection between the closure member 102 and the bottom wall 78 of the fluid reservoir 34 inhibits accidental loss of the closure member 102 while the reservoir fluid inlet port 100 is exposed, and enables the joint between the closure member 102 and the fluid reservoir 34 to be located between the handle 12 and the fluid reservoir 34 when the cleaning tool 14 is mounted on the handle 12. As shown in FIG. 3, the lower parts of the arms 106 of the closure member 102 are located within a recessed section of the bottom wall 78 of the fluid reservoir 34 when the closure member 102 is in its closed position so that the bottom surfaces of the lower parts of the arms 106 are substantially flush with the bottom wall 78 of the fluid reservoir 34.

At least part of the external wall of the fluid reservoir 34 is preferably transparent to allow a user to observe the contents of the fluid reservoir 34, and so assess whether the fluid reservoir 34 requires replenishment prior to the desired use of the appliance 10. The external wall preferably has a shape which is symmetrical about the longitudinal axis of the cleaning tool 14. The external wall preferably has a curved shape, more preferably a convex curved shape, but alternatively the external wall may have a polygonal or faceted shape. In this embodiment, the external wall has a spherical curvature. As described below, the fluid reservoir 34 is mounted on the relatively wide base section 88 of the stem 26, and so the external wall has opposed circular apertures which are centred on the longitudinal axis of the cleaning tool 14 to allow the base section 88 of the stem 26 to pass therethrough.

The fluid reservoir 34 further comprises an inner wall 112 which is connected to the external wall, and which with the external wall defines the capacity of the fluid reservoir 34. The inner wall 112 is tubular in shape. The ends of the inner wall 112 are preferably circular in shape, and are connected to the external wall so as to form a water-tight seal between the external wall and the inner wall 112. In this embodiment, the fluid reservoir 34 is formed from two housing parts. A first housing part 114 comprises an upper section of the external wall and the inner wall 112, and so the upper end of the inner wall 112 is integral with an upper section of the external wall. A second housing part 116 comprises a lower section of the external wall and the bottom wall 78 of the fluid reservoir 34.

To mount the fluid reservoir 34 on the stem 26, the circular aperture formed in the first housing part 114 of the fluid reservoir 34 is aligned with the free end of the base section 88 of the stem 26, and the fluid reservoir 34 is pushed on to the stem 26. The internal surface of the inner wall 112 of the fluid reservoir 34 bears against the base section 88 of the stem 26 so that frictional forces therebetween prevent the fluid reservoir 34 from falling from the stem 26. To mount the cleaning tool 14 on the handle 12, the spigot 70 of the handle 12 is aligned with the recess 73 formed in the connector 72 of the cleaning tool 14, and the handle fluid outlet port 82 located adjacent to the spigot 70 is aligned with the cleaning tool fluid inlet port 86 of the cleaning tool 14. The cleaning tool 14 is then pushed on to the spigot 70 so that the handle fluid outlet port 82 connects to the cleaning tool fluid inlet port 86, and so that the fluid reservoir 34 engages the annular seat 76 to connect the reservoir fluid outlet port 80 to the fluid inlet 44 of the fluid delivery system 40. The internal surface of the connector 72 of the stem 26 bears against the external surface of the spigot 70 so that frictional forces therebetween retain the stem 26 on the handle 12. The connector 72 is preferably formed from resilient plastics material which flexes as the connector 72 is pushed on to the spigot 70 to increase the frictional forces therebetween. A spring clip 120 may be provided at least partially about the connector 72 for urging the internal surface of the connector 72 against the spigot 70.

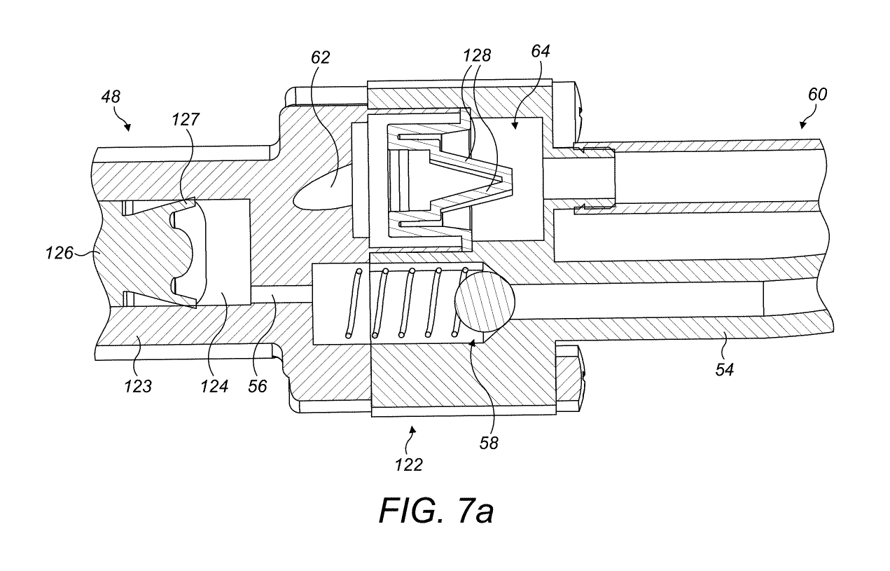

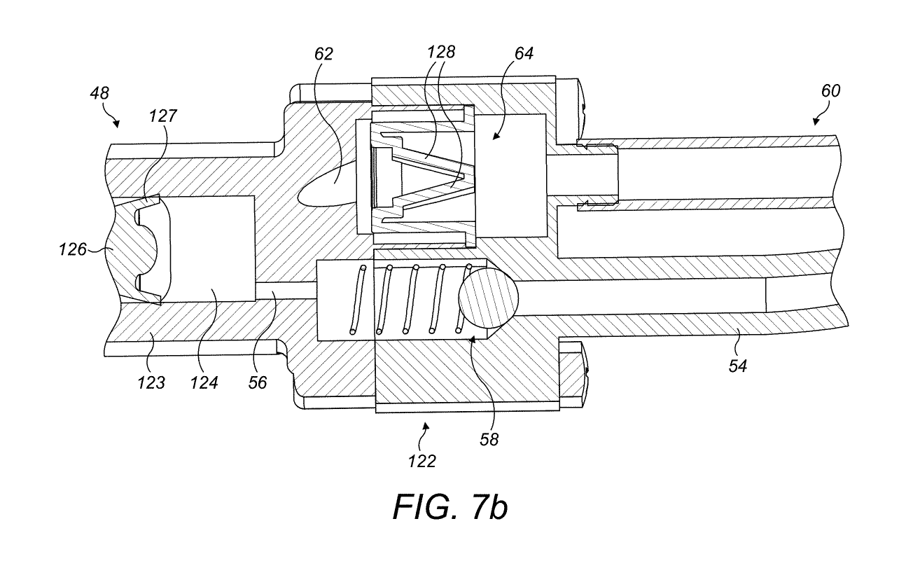

With reference to FIGS. 6 and 7, the valves 58, 64 of the fluid delivery system 40 are housed within a valve housing 122 connected to the pump 48. The pump 48 comprises a pump housing 123 in which the fluid inlet 56 and the fluid outlet 62 (partially visible in FIGS. 7(a) and 7(b)) are formed. The pump housing 123 defines a fluid chamber 124 for receiving water through the fluid inlet 56, and from which water is ejected through the fluid outlet 62. The pump 48 comprises a fluid displacement member which is moveable relative to the fluid chamber 124 to draw water into the fluid chamber 124, and subsequently to urge a burst of water from the fluid chamber 124 towards the nozzle 36. The fluid displacement member is preferably reciprocally moveable relative to the fluid chamber 124. In this embodiment, the pump 48 is in the form of a piston pump, in which the fluid displacement member is a piston 126 which is moveable within the fluid chamber 124. The piston 126 is moveable from a first position, as shown in FIG. 7(a), and in a first direction, to draw water into the fluid chamber 124 from the fluid reservoir 34. The piston 126 is also moveable from a second position, as shown in FIG. 7(b), and in a second direction, opposite to the first direction, to subsequently urge a burst of water from the fluid chamber 124 towards the nozzle 36. In this example, the piston 126 is a relatively rigid member which is moveable within the fluid chamber 124 along a first linear path between linearly spaced positions. A piston seal 127, which may be an O-ring, extends about the piston 126 to form a water-tight seal between the fluid chamber 124 and the piston 126. Alternatively, the pump may be in the form of a diaphragm pump, in which the fluid displacement member is a diaphragm bounding one side of the fluid chamber 124. In such a pump, the diaphragm is moveable, through flexing thereof, between different configurations. The pump 48 is normally maintained in a primed configuration, with the piston 126 held in a position within the fluid chamber 124 following the drawing of a volume of water into the fluid chamber 124 so that the pump assembly 46 may respond rapidly to a signal received by the control circuit 66 instructing the ejection of a burst of water from the nozzle 36.

The first valve 58 is a one-way valve located between the first conduit 54 and the fluid inlet 56 of the pump 48. In this embodiment, the first valve 58 comprises a ball check valve having a spring-loaded ball which is urged against a valve seat to prevent fluid from being urged into the first conduit 56 as the piston 126 moves in the second direction to urge a burst of water from the pump 48.

The second valve 64 comprises a one-way valve located between the second conduit 60 and the fluid outlet 62 of the pump 48. In this embodiment, the second valve 64 comprises a duckbill valve, comprising a pair of flexible valve members 128 defining a slot opening which is normally closed by the valve members 128. As the piston 126 moves in the second direction to urge a burst of water from the pump 48, the force exerted on the second valve 64 by the pressurized water causes the valve members 128 to deform outwardly to open the slot opening and permit the burst of water to flow into the second conduit 60. As the piston 126 moves in the first direction to draw a second volume of water into the fluid chamber 124, the valve members 128 deform inwardly, keeping the slot opening closed to prevent water from being drawn into the fluid chamber 124 from the second conduit 60.

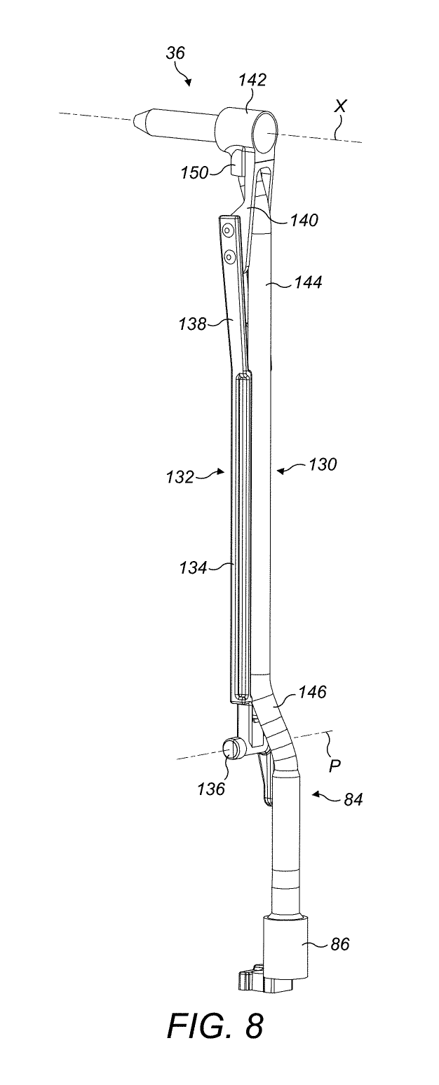

Turning to FIGS. 6 to 9, the cleaning tool conduit section 84 comprises a fluid conduit 130 for conveying fluid from the cleaning tool fluid inlet port 86 to the nozzle 36. The nozzle 36 is mounted on a support 132 which supports the nozzle 36 for movement relative to the handle 12 and to the stem 26 of the cleaning tool 14. The support 132 comprises an elongate body 134 which is connected to the stem 26 for pivoting movement about a pivot axis P. For example, the support 132 may comprise a cylindrical boss 136 which is retained between a pair of spaced recesses formed in the base 88 of the stem 26. Pivot axis P passes through the stem 26, and is substantially orthogonal to the longitudinal axis of the stem 26. The support 132 is generally Y-shaped, having a pair of arms 138 which extend upwardly from the body 134 and which are each connected to a respective leg 140 of the body 142 of the nozzle 36.

The nozzle 36 is moveable relative to the handle 12 between a first, or distal, position, and a second, or proximal, position. In the distal position, the tip of the nozzle 36 protrudes outwardly beyond the ends of the bristles 32, whereas in the proximal position, the tip of the nozzle 36 is retracted relative to the ends of the bristles 32. In this embodiment, the nozzle 36 is biased for movement towards the distal position. The fluid conduit 130 comprises a relatively rigid section 144 which is connected to the nozzle 36, and a relatively flexible section 146 located between the relatively rigid section 144 and the cleaning tool fluid inlet port 86, and which is housed within the stem 26 so as to be in an elastically deformed configuration. With reference to FIG. 7, the internal force created within the relatively flexible section 146 of the fluid conduit 130 acts in such a direction to urge the relatively rigid section 144 of the fluid conduit 130 towards the connecting rod 94. Through the connections made between the fluid conduit 130, the nozzle 36 and the support 132, this internal force causes the nozzle 36 to pivot about the pivot axis P in such a direction that urges the nozzle 36 towards the distal position relative to the brush unit 29.

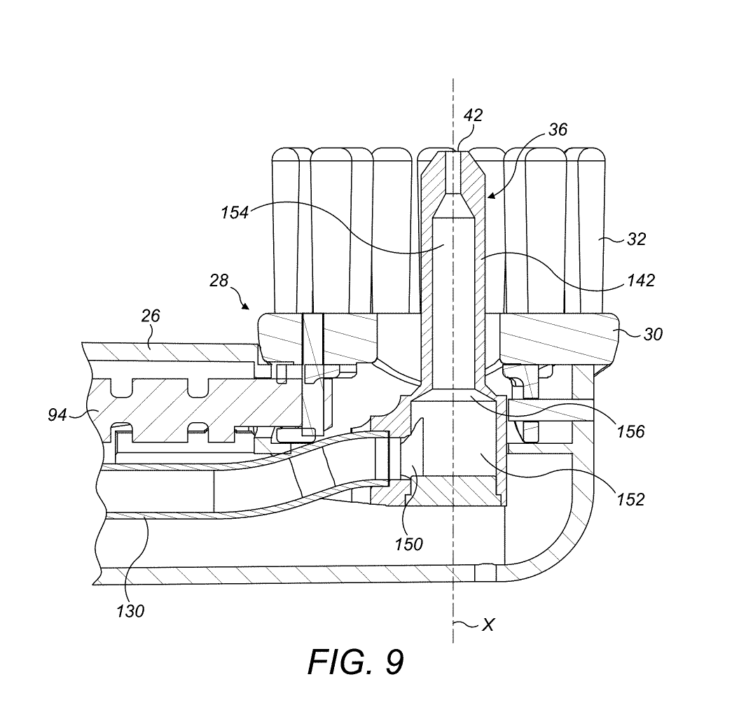

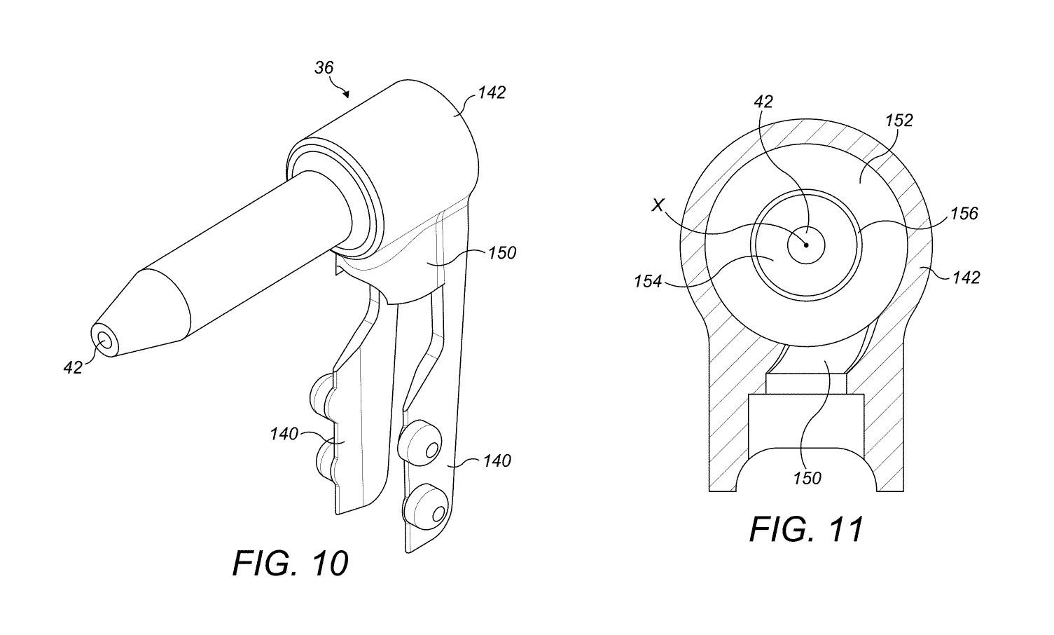

The fluid conduit 130 passes between the legs 140 of the body 142 of the nozzle 36 to connect to a fluid inlet 150 of the nozzle 36. With particular reference to FIG. 9, the fluid inlet 150 is a tangential inlet which conveys fluid tangentially into a fluid chamber 152 defined by the body 142 of the nozzle 36. In this embodiment, the fluid chamber 152 is cylindrical in shape, and extends about a longitudinal axis X which is collinear with the longitudinal axis of the nozzle 36. The diameter of the fluid chamber 152 is preferably in the range from 2 to 7 mm, and in this embodiment is around 4 mm.

The body 142 of the nozzle 36 also defines a cylindrical fluid channel 154 which is located downstream from the fluid chamber 152, and which conveys working fluid from the fluid chamber 152 to the fluid outlet 42 of the nozzle 36. The fluid channel 154 is centered on, and extends about the longitudinal axis X. The diameter of the fluid channel 154 is preferably in the range from 1.5 to 3 mm, and in this embodiment is around 2 mm. A fluid port 156 for conveying fluid from the fluid chamber 152 to the fluid channel 154 is centered on the longitudinal axis X. The fluid port 156 is frustoconical in shape, converging towards the fluid channel 154. The fluid outlet 42 of the nozzle 36 is also centered on the longitudinal axis X. The fluid outlet preferably has a diameter in the range from 0.5 to 1.5 mm, and in this embodiment is around 0.7 mm. The transition between the fluid channel 154 and the fluid outlet 42 of the nozzle 36 is preferably frustoconical so that there is a relatively gradual reduction in the diameter of the fluid flow path between the fluid channel 154 and the fluid outlet 42.

To operate the appliance 10, the user presses buttons 18, 20, 22 located on the handle 12. The user switches on the appliance 10 by depressing button 18, the action of which is detected by the control circuit 66. The user may select a mode of operation of the appliance 10 by depressing button 20. For example, through pressing button 20 once, the control circuit 66 may activate the motor to move the brush unit 29 relative to the handle 12. Pressing that button 20 again may switch off the motor. When the button 22 is pressed, the control circuit 66 activates the pump 48 to move the piston 126 in the second direction to urge a burst of water from the fluid chamber 124 of the pump 48 through the second valve 64 and into the second conduit 60. The burst of water is conveyed by the second conduit to the fluid inlet 150 of the nozzle 36. The pump 48 is preferably configured to generate a burst of water which has a static pressure in the range from 3 to 10 bar at the fluid inlet 150 of the nozzle 36. As the water burst enters the fluid chamber 152 through the fluid inlet 150, a swirl of water droplets is generated about the longitudinal axis X of the fluid chamber 152 due to the angled entry of the water burst into the fluid chamber 152. The swirling water droplets pass through the fluid port 156 into the fluid channel 154, and are subsequently emitted from the fluid outlet 42 of the nozzle 36 in the form of a swirling cone of water droplets. The time between the activation of the pump 48 to generate the water burst and the emission of the water burst from the nozzle 36 is preferably in the range from 10 to 50 ms, more preferably between 15 and 30 ms.

Once the fluid burst has been ejected from the nozzle 36, the control circuit 66 activates the pump 48 to move the piston 126 in the first direction to draw a second volume of water into the fluid chamber 124 from the fluid reservoir 34 for forming a subsequent water burst. As the piston 126 moves in the first direction, that is, away from the fluid outlet 62 of the pump 48, a pressure differential is created across the flexible members 128 of the second valve 64 which causes the flexible members 128 to flex inwardly towards the fluid outlet 62 of the pump 48 to close the slot opening, as shown in FIG. 7(b). The movement of the flexible members 128 towards the fluid outlet 62 of the pump 48 creates a localised region of relatively low pressure within the portion of the fluid delivery system 40 located downstream of the second valve 64, which causes the water within that portion of the fluid delivery system 40 to be drawn back towards the second valve 64. As a result, water remaining within the fluid channel 154 of the nozzle 36 is drawn back into the fluid chamber 152 of the nozzle 36, which prevents that water from dripping from the fluid outlet 42 of the nozzle 36 between the delivery of bursts of water from the nozzle 36.

Parameters of the second valve 64, such as the size and the flexibility of the flexible members 128, may be selected to control the volume of fluid which is drawn back into the fluid chamber 152 of the nozzle 36, an thus control the position of the meniscus of the water located within the cleaning tool conduit section 84. For example, between the delivery of bursts of water from the appliance 10, the meniscus may be positioned (i) within the fluid channel 154, for example at a position located more proximate to the fluid port 156 than the fluid outlet 42, (ii) within the fluid chamber 152, or (iii) upstream from the fluid inlet 150 of the fluid chamber 152. When the meniscus is located within, or upstream from, the fluid chamber 152, a volume of air, which has been drawn into the nozzle 36 through the fluid outlet 42, is present within the fluid chamber 152. When a second burst of water is ejected from the pump 48, that volume of air mixes with the water urged through the cleaning tool conduit section 84 to form a burst of working fluid, comprising both air and water, which is ejected from the fluid outlet 42 of the nozzle 36.

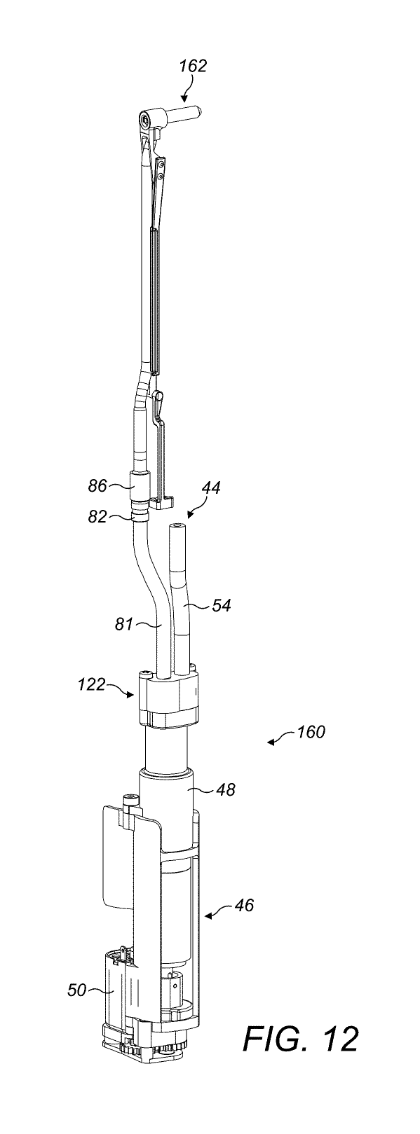

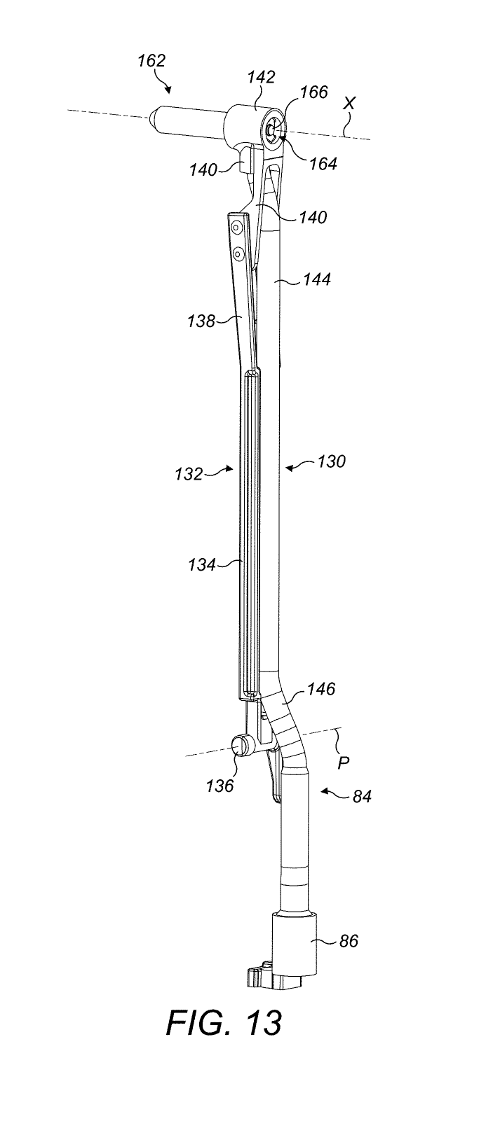

Instead of drawing air into the fluid delivery system 40 through the fluid outlet 42 of the nozzle 36, air may be introduced into the fluid delivery system 40 through a separate air inlet. FIGS. 12 to 14 illustrate parts of a second embodiment of a fluid delivery system 160 of the appliance 10, in which features which are the same as those of the first embodiment of the fluid delivery system 40 are identified with the same reference numerals. In this second embodiment, the nozzle 36 of the fluid delivery system 40 is replaced by a nozzle 162 which comprises an air inlet 164 for conveying air into the fluid chamber 152 of the nozzle 162. The air inlet 164 is located on the side of the fluid chamber 152 which is opposite to the fluid port 156 through which fluid is conveyed from the fluid chamber 152 into the fluid channel 154. A first one way valve 166 is located in the air inlet 164 for preventing liquid from passing through the air inlet 164 from the fluid chamber 152. The first one way valve 166 comprises a valve member 168 which is urged against a valve seat 170 by the burst of water received by the nozzle 162 from the second conduit 60, and which is moveable away from the valve seat 170 as the flexible members 128 of the second valve 60 flex inwardly towards the fluid outlet 62 of the pump 48 to allow air to be drawn into the fluid chamber 152.

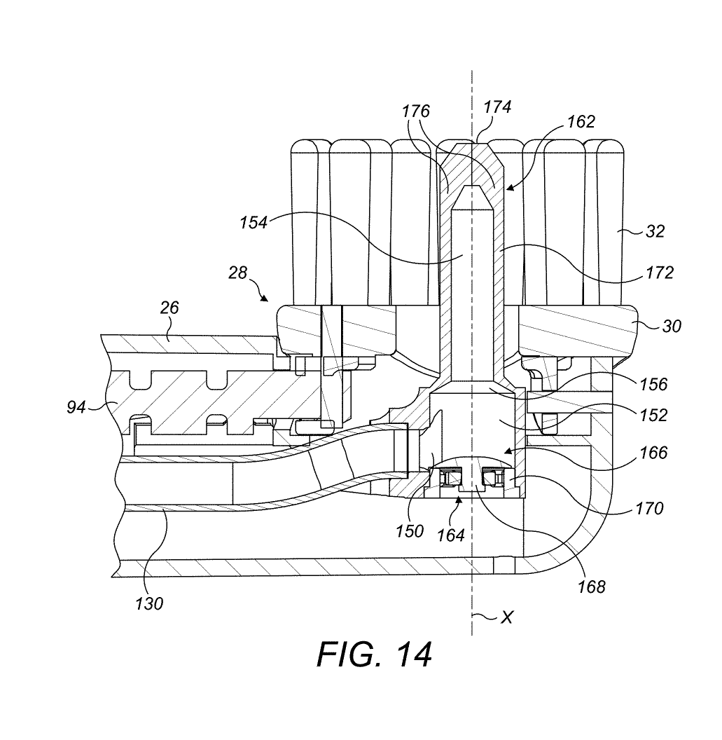

As illustrated in FIG. 14, the body 172 of the nozzle 162 may define a second one way valve at the fluid outlet 174. The body 172 of the nozzle 162 may be formed from a pair of flexible valve members 176 defining a slot-like fluid outlet 174 which is normally closed by the valve members 176. As the burst of water enters the nozzle 162 from the pump 48, the force exerted on the flexible members 176 by the pressurized water causes the valve members 176 to deform outwardly to open the fluid outlet 174 and permit the burst of fluid, formed from the burst of water received by the nozzle 162 and air which has been previously drawn into the fluid chamber 152 through the air inlet 164, to be emitted from the nozzle 162. Following the ejection of the burst of fluid from the nozzle 162, the flexible members 176 flex inwardly to close the fluid outlet 174 to prevent air from being drawn into the nozzle 162 through the fluid outlet 174.

1. A dental cleaning appliance comprising:
a liquid reservoir for storing a working liquid; and
a fluid delivery system for delivering a burst of working liquid to the teeth of the user, the fluid delivery system comprising:
a fluid emission nozzle comprising a fluid chamber, a fluid outlet and a channel extending between the fluid chamber and the fluid outlet,
a liquid burst generator,
a fluid conduit for conveying a burst of working liquid from the liquid burst generator to the nozzle, and
a valve for drawing fluid into the fluid chamber of the nozzle following the delivery of a burst of working liquid to the teeth of the user.

2. The appliance of claim 1, wherein the valve is configured to draw working liquid back into the fluid chamber from the channel.

3. The appliance of claim 1, wherein the valve is configured to draw a volume of air into the fluid delivery system.

4. The appliance of claim 3, wherein the valve is configured to draw a volume of air into the fluid chamber as working liquid is drawn back into the fluid chamber from the channel.

5. The appliance of claim 3, wherein the valve is configured to draw air into the fluid chamber through the fluid outlet of the nozzle.

6. The appliance of claim 3, comprising an air inlet through which air is drawn into the fluid delivery system by the valve.

7. The appliance of claim 6, wherein the nozzle comprises said air inlet, said air inlet being spaced from the fluid outlet of the nozzle.

8. The appliance of claim 7, wherein the air inlet is located opposite to the fluid outlet.

9. The appliance of claim 6, comprising a one way valve for inhibiting the emission of working liquid through the air inlet.

10. The appliance of claim 9, wherein the nozzle comprises a second one way valve for inhibiting the drawing of air into the fluid chamber through the fluid outlet.

11. The appliance of claim 10, wherein the second one way valve is located at or adjacent the fluid outlet.

12. The appliance of claim 10, wherein the fluid outlet of the nozzle is in the form of a one way valve.

13. The appliance of claim 10, wherein the fluid outlet comprises a duckbill valve.

14. The appliance of claim 1, wherein the valve is located in a fluid flow path extending from the liquid burst generator to the nozzle.

15. The appliance of claim 1, wherein the valve is located adjacent to the liquid burst generator.

16. The appliance of claim 1, wherein the valve is located in a housing of the liquid burst generator.

17. The appliance of claim 1, wherein the valve is located adjacent to the fluid outlet from the liquid burst generator.

18. The appliance of claim 1, wherein the valve comprises a one way valve.

19. The appliance of claim 1, wherein the valve comprises a duckbill valve.

20. The appliance of claim 1, comprising a handle, and a stem extending between the handle and the nozzle, and wherein the liquid burst generator is located in the handle.

21. The appliance of claim 1, wherein the liquid burst generator comprises a positive displacement pump.

22. The appliance of claim 21, wherein the positive displacement pump comprises a fluid displacement member which is actuable to draw working liquid into the pump from the liquid reservoir, and to urge a burst of working liquid from the pump towards the nozzle.

23. The appliance of claim 22, wherein the valve is arranged to draw working liquid back into the fluid chamber of the nozzle as the fluid displacement member is actuated to draw working liquid into the pump from the liquid reservoir.

24. The appliance of claim 22, wherein the valve is arranged simultaneously to inhibit the drawing of working liquid back into the pump from the fluid conduit as the fluid displacement member is actuated to draw working liquid into the pump from the liquid reservoir.

25. A dental cleaning appliance comprising:
a nozzle comprising a fluid chamber, a fluid outlet and a channel extending between the fluid chamber and the fluid outlet;
a liquid reservoir for storing a working liquid;
a pump comprising a fluid displacement member which is actuable to draw a volume of working liquid into the pump from the liquid reservoir, and to urge a burst of working liquid from the pump towards the nozzle;
a fluid conduit for conveying the burst of working liquid towards the fluid chamber; and
a valve for, following the delivery of the burst of working liquid to the teeth of the user, (i) preventing working liquid from being drawn back into the pump from the fluid conduit as the fluid displacement member is actuated to draw a second volume working liquid into the pump from the liquid reservoir, and (ii) simultaneously, drawing fluid into the fluid chamber.
